(19) United States
(12) Patent Application Publication
(10) Pub. No.: US 2007/0044854 A1
(43) Pub. Date: Mar. 1, 2007

(54) PNEUMATIC CONTROLLER FOR COMPRESSED-AIR GUN

(76) Inventor: Jui-Fu Tseng, Jhonghe City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/162,021

(22) Filed: Aug. 25, 2005

(51) Int. Cl. F16K 1/30

(52) U.S. Cl. 137/614.2

(57) ABSTRACT

A pneumatic controller for a compressed-air gun has a shell, a hollow cylinder inside which defines a first space extending along the axis thereof, having a first through hole and a second through hole extend through a wall of the shell at two opposed positions; a guiding structure, a hollow cylinder defining a second space being coaxial with the shell therein having a first annular recess formed a plurality of first orifices and a second annular recess formed a plurality of second orifices which correspond to the first through hole and the second through hole respectively; and a column contained and restricted in the second space of the guiding structure for choosing whether first orifices of the first guiding component connect the second orifices of the second guiding component by the second space. Furthermore, the column has a third annular recess which is formed on the surface of the column and corresponds to the distance between the first orifices and the second orifices; and the column blocks in the second space to disconnect the first orifices from a first state and the second orifices when the column shifts to a second state for connecting the first orifices and the second orifices by the third annular recess.

### BACKGROUND OF THE INVENTION

1. Field of the Invention

The present invention relates to a pneumatic controller for a compressed-air gun, and more particularly to a pneumatic controller that prevents the residual air in the cylinder sleeve blocking injection of the air from the pneumatic controller while the percussion of the gun is operated continuously.

2. Description of Related Art

Compressed-air guns have become very popular whereby paintballs can be fired to clearly yet harmlessly hit opponents. A magazine is loaded with the paintballs to give an automatic weapon style, and this rapid-fire feature enhances the excitement of such guns. Usually, this kind of the apparatus uses compressed air or gas to produce the force for firing the paintballs. However, the compressed-air guns about prior arts have some problems during continuously firing. One of these problems is that the residual air of the last firing will block the next injection of the air then the next firing will be delayed until the residual air is drained off.

Because of the drawbacks of the prior arts, the present invention provides a pneumatic controller for a compressed air gun to overcome the prior arts.

### SUMMARY OF THE INVENTION

The primary objective of the present invention is to provide a pneumatic controller for a compressed-air gun to make the compressed air current particularly smooth.

Another objective of the present invention is to provide a pneumatic controller for a compressed-air gun to prevent the residual air in the cylinder sleeve blocking injection of the air from the pneumatic controller while the percussion of the gun is operated continuously.

For the purposes above, the present invention provides a pneumatic controller actuated for percussion of a compressed-air gun. The pneumatic controller has a shell, a hollow cylinder inside which defines a first space extending along the axis thereof, having a first through hole and a second through hole which extend through a wall of the shell at two opposite positions; a guiding structure, a hollow cylinder defining a second space being coaxial with the shell therein having a first annular recess formed a plurality of first orifices and a second annular recess formed a plurality of second orifices which correspond to the first through hole and the second through hole respectively; and a column contained in and restricted in the second space of the guiding structure for selecting whether the first orifices of the first guiding component connect the second orifices of the second guiding component by the second space. Furthermore, the column has a third annular recess which is formed on the surface of the column and corresponds to the distance between the first orifices and the second orifices; and the column blocks in the second space to disconnect the first orifices from a first state and the second orifices while the column shifts to a second state for connecting the first orifices and the second orifices by the third annular recess.

Other and further features, advantages and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

FIG. 1 is an exploded perspective view of an embodiment according to a pneumatic controller of the present invention;

FIG. 2 is a sectional view of FIG. 1 according to the pneumatic controller of the present invention;

FIG. 3 is a sectional view of a first state according to a compressed-air gun in operation with the pneumatic controller of the present invention;

FIG. 4 is a sectional view of a second state according to a compressed-air gun in operation with the pneumatic controller of the present invention;

FIG. 5 is a sectional view of a third state according to a compressed-air gun in operation with the pneumatic controller of the present invention.

### DETAILED DESCRIPTION OF THE PREFFERED EMBODIMENT

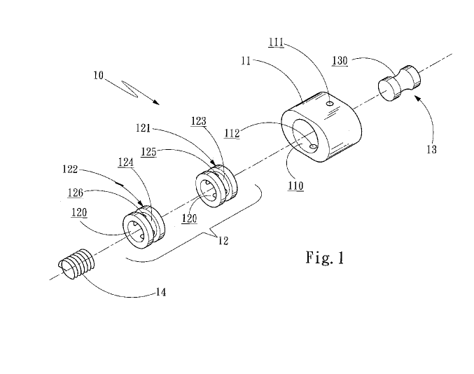

With reference to FIG. 1, a pneumatic controller (10) for a compressed-air gun in accordance with the present invention is mainly composed of a shell (11), a guiding structure (12), a column (13), and an elastic component (14).

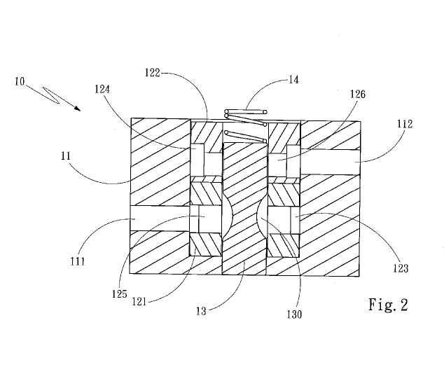

With reference to FIGS. 1 and 2, the shell (11) is a hollow cylinder which defines a first space (110) extending along the longitudinal axis of the shell (11), and the shell (11) has a first through hole (111) and a second through hole (112) which extend through a wall of the shell (11) at opposed sides yet are staggered in relation to each other. The guiding structure (12) has a first guiding component (121) and a second guiding component (122) which respectively correspond to the first through hole (111) and the second through hole (112), and each of the guiding components (121) and (122) is a hollow cylinder which defines a second space (120) being coaxial with the shell (11). Moreover, the first guiding component (121) has a first annular recess (123) while the second guiding component (122) has a second annular recess (124), and the first annular recess (123) and the second annular recess (124) respectively have a plurality of first orifices (125) and second orifices (126) thereof. Each of the orifices (125) and (126) radially extends through to the second space (120) so that the orifices (125) and (126) make the air current especially smooth. The column (13) is contained and restricted in the second space (120) of the guiding structure (12) for selecting whether the first orifices (125) of the first guiding component (121) connect the second orifices (126) of the second guiding component (122) by the second space (120). Moreover, the column (13) has a third annular recess (130) which is formed on the surface of the column (13) and is corresponding to the distance between the first orifices (125) and the second orifices (126). Therefore, at a first state, the column (13) blocks in the second space (120) to disconnect the first orifices (125) and the second orifices (126) when the column (13) shifts to a second state for connecting the first orifices (125) and the second orifices (126) by the third annular recess (130). The elastic component (14), a spring for an example, is installed at one end of the shell (11) to restrict the column (13). The column (13) is actuated by a mechanical force, such that the column (13) moves to the second state and compresses the elastic component (14) when the column (13) moves back to the first state by stored energy of the elastic component (14) when the mechanical force is released.

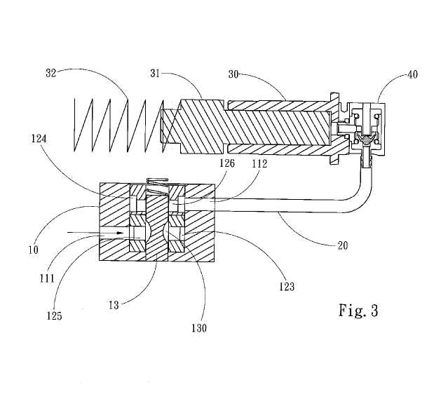

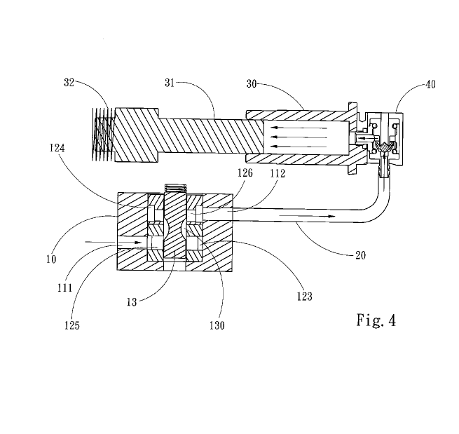

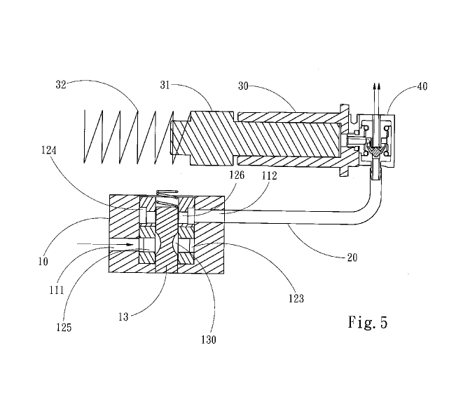

With reference to FIG. 3, FIG. 4 and FIG. 5, the pneumatic controller for a compressed-air gun in accordance with the present invention, when the column (13) of the pneumatic controller (10) is actuated, the third annular recess (130) of the column (13) connects the first orifices (125) of the first annular recess (123) and the second orifices (126) of the second annular recess (124) for high pressure air to flow from the first through hole (111) to the second through hole (112) and then being vented. Because the first annular recess (123) and the second annular recess (124) have the orifices (125) and (126) respectively thereon, the high pressure air flows particularly smoothly. Then, the high pressure air vented from the second through hole (112) flows through a conduit (20), and is injected into one end of a cylinder sleeve (30). The cylinder sleeve (30) contains and restricts a piston column (31) at another end thereof. An outer end of the piston column (31) has a returning device (32). Therefore, the pneumatic controller (10) can choose the high pressure air to flow into the cylinder sleeve (30) and drive the piston column (31) to move so that percussion acted by the piston column (31) is pushed by the compressed air and the returning device (32) is compressed at the same time. The returning device (32) can return the piston column (31) to the first state. Further, a non-return device (40) is installed between the conduit (20) and the cylinder sleeve (30) to prevent backflow of the air when the mechanical force actuating the column (13) to compress the elastic component (14) is released. After the returning device (32) has been released, the piston column (31) returns to the first state and compresses residual air in the cylinder sleeve (30), and the non-return device (40) vents the residual air from the cylinder sleeve (30). The residual air in the cylinder sleeve (30) does not flow back to the pneumatic controller (10) through the conduit (20) so that the pneumatic controller for compressed-air gun in accordance with the present invention prevents the residual air in the cylinder sleeve (30) blocking injection of the air from the pneumatic controller (10) while the percussion of the gun is operated continuously.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A pneumatic controller for a compressed-air gun, comprises:
a shell, a hollow cylinder inside which defines a first space extending along a longitudinal axis thereof, having a first through hole and a second through hole extending through a wall of the shell at two opposed sides yet being staggered relative to each other on a common axis; a guiding structure, a hollow cylinder defining a second space being coaxial with the shell therein, comprising:
a first annular recess corresponding to the first through hole having a plurality of first orifices which radially extend through to the second space; and
a second annular recess corresponding to the second through hole having a plurality of second orifices which radially extend through to the second space; and
a column contained and restricted in the second space of the guiding structure adapted to select the first orifices of the first guiding component connect the second orifices of the second guiding component by the second space;
wherein the column has a third annular recess formed on a surface of the column and correspond to a distance between the first orifices and the second orifices; and
the column plugs the second space to disconnect the first orifices a first state and the second orifices when the column shifts to a second state for connecting the first orifices and the second orifices by the third annular recess.

2. The pneumatic controller for a compressed-air gun of claim 1, wherein the guiding structure comprises a first guiding component and a second guiding component forming the first annular recess and the second guiding component respectively.

3. The pneumatic controller for a compressed-air gun of claim 1, wherein the column further comprises an elastic component installed at one end of the shell to restrict the column, and the column moves back to the first state by the elastic component when a mechanical force restricted the column is released.

4. The pneumatic controller for a compressed-air gun of claim 2, wherein the column further comprises an elastic component installed at one end of the shell to restrict the column, and the column moves back to the first state by the elastic component when a mechanical force restricted the column is released.

5. The pneumatic controller for a compressed-air gun of claim 1, wherein the pneumatic controller further comprises a non-return device connecting the second through holes and the cylinder sleeve to prevent backflow of air.

6. The pneumatic controller for a compressed-air gun of claim 2, wherein the pneumatic controller further comprises a non-return device connecting the second through holes and the cylinder sleeve to prevent backflow of air.

7. The pneumatic controller for a compressed-air gun of claim 3, wherein the pneumatic controller further comprises a non-return device connecting the second through holes and the cylinder sleeve to prevent backflow of air.

8. The pneumatic controller for a compressed-air gun of claim 4, wherein the pneumatic controller further comprises a non-return device connecting the second through holes and the cylinder sleeve to prevent backflow of air.
